(19) United States
(12) Patent Application Publication
(10) Pub. No.: US 2022/0176255 A1
(43) Pub. Date: Jun. 9, 2022

(54) Method and related Systems for Displaying a Multiplayer Game

(71) Applicant: Eugene Giordani, Hewlett, NY (US)

(72) Inventor: Eugene Giordani, Hewlett, NY (US)

(21) Appl. No.: 17/531,716

(22) Filed: Nov. 20, 2021

Related U.S. Application Data
(60) Provisional application No. 63/122,819, filed on Dec. 8, 2020.

(51) Int. Cl. A63F 13/798; A63F 13/35

(52) U.S. Cl. CPC A63F 13/798; A63F 13/35

(57) ABSTRACT

The present disclosure provides an integrated method for managing progression of a tournament and automatically configuring and pairing live streams of opposing tournament participants. The method can be applied to both one vs one and team vs team style tournament games. In particular, an algorithm is trained to generate match pairings and detect when a participant or team of participants have won the match then pair them with another winning participant or team in a subsequent round. The method saves a significant amount of effort on the part of the tournament participant wanting to broadcast their gameplay and provides an easy interface for viewers to switch between the perspectives of different participants.

### FIELD OF INVENTION

The present invention relates generally to the field of live streaming. More specifically, the present invention relates to a method for automatic pairing and display of live streams of participants in a tournament game.

### BACKGROUND

The field of e-sports is fast growing, commanding significant viewership and large commercial interests. Many competitive modern games offer multiplayer experiences where opposing teams compete and progress in a tournament style format, and it is often desired by the tournament participants that they can broadcast/stream their gameplay to interested audiences.

Despite this, there is no technology currently available that allows the process of tournament streaming to be automated. Players must manually set up the match using the game interface, then switch to a separate interface to set up their broadcast, and often need a third platform to generate match pairings and determine who plays who as the tournament rounds progress. This is inconvenient and can lead to long delays between matches. It also significantly limits the number of participants that can practically take part in a tournament.

It is within this context that the present invention is provided.

### SUMMARY

The present disclosure provides an integrated method for managing progression of a tournament and automatically configuring and pairing live streams of opposing tournament participants. The method can be applied to both one vs one and team vs team style tournament games. In particular, an algorithm is trained to generate match pairings and detect when a participant or team of participants have won the match then pair them with another winning participant or team in a subsequent round. The method saves a significant amount of effort on the part of the tournament participant wanting to broadcast their gameplay and provides an easy interface for viewers to switch between the perspectives of different participants.

Thus, according to one aspect of the present disclosure there is provided a computer-implemented method of displaying a multiplayer game in a tournament comprising one or more rounds, the method comprising: (a) receiving user data comprising a list of tournament participants; (b) generating a set of first round matches by pairing each tournament participant in a match with one or more other tournament participants; (c) broadcasting a display of each of the first round matches, each broadcasted display comprising a live stream of an in-game view for the one or more tournament participants in the match; (d) for each first round match broadcast, detecting a visual trigger in the display indicating that the match has ended and thereby determining one or more winning tournament participants and one or more losing tournament participants; (e) generating a set of second round matches by pairing one or more winning tournament participants with one or more other winning participants; and (f) repeating steps (c)-(e) for each successive tournament round until one or more tournament winners are determined.

In some embodiments, each match comprises opposing teams of first and second sets of tournament participants, and wherein step (c) comprises broadcasting a live stream for each participant of each team.

The method may further comprise pairing losing participants for each round subsequent to the first round and broadcasting the live streams of the losing participants.

Furthermore, step (d) may be carried out by a machine learning algorithm that has been trained to detect visual triggers and determine winning participants based on the in-game display of a particular game that is being played. In such embodiments the visual trigger may be an in-game event which is automatically generated once a game has ended.

In some embodiments the live streams of the in-game displays are broadcast on a streaming website. Furthermore, for team games the streaming website may display two team names indicating the teams that are playing.

Additionally, for team games the streaming website may display an enlarged in-game view for a particular tournament participant on each team. The display may further comprise a set of thumbnails representing one or more tournament participants on the same team as the displayed tournament participant, and the streams of the one or more team members can be accessed via the respective thumbnails.

### BRIEF DESCRIPTION OF THE DRAWINGS

Various embodiments of the invention are disclosed in the following detailed description and accompanying drawings.

FIG. 1 illustrates a flow diagram of a core set of steps of the method of the present disclosure.

FIG. 2 illustrates an example in-game interface for a tournament participant that an algorithm may recognise a visual trigger from according to the disclosed method.

FIG. 3 illustrates an example interface displaying a multiplayer game where live streams of tournament participants have been paired and displayed according to an embodiment of the present disclosure.

FIG. 4 illustrates other aspects of the example interface displaying a multiplayer game where live streams of tournament participants have been paired and displayed according to the embodiment of the present disclosure.

FIG. 5 illustrates an example system and network architecture through which the method of the present disclosure may be implemented.

FIG. 6 illustrates an example configurations of a the electronic components of a user device capable of viewing a game tournament displayed according to the method of the present disclosure.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

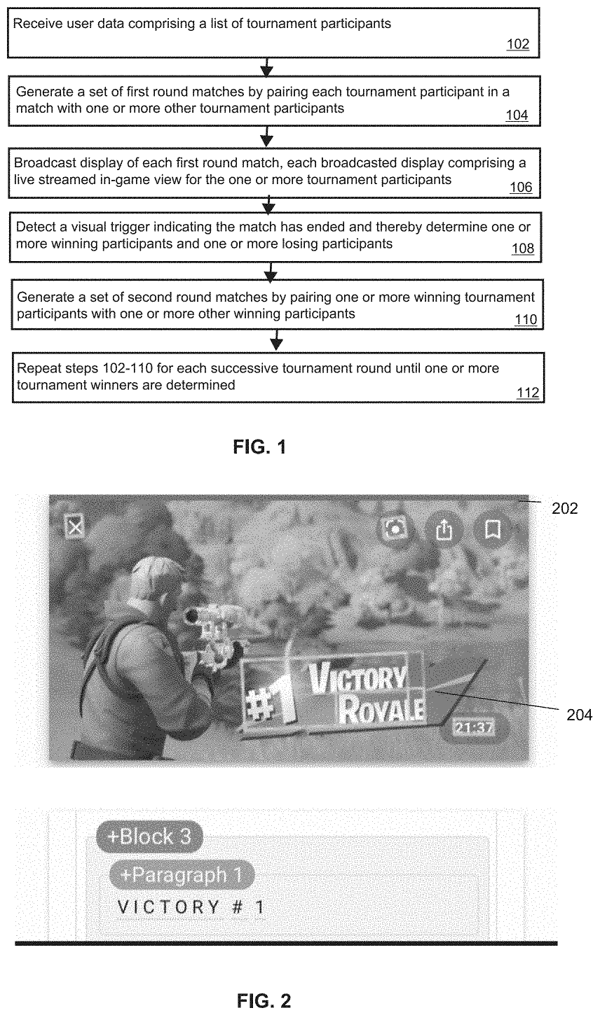

Referring to FIG. 1 a flow diagram of a core set of steps of the method of the present disclosure is shown.

In a first step 102, the method involves receiving user data comprising a list of tournament participants. The user data may have the user names of the participants, the various teams which they are playing on if the tournament is being hosted for a multiplayer game, and may also comprise data such as the associated webpage or username on a website with which the participant is live streaming.

In a second step 104 the method involves generating a set of first round matches by pairing each tournament participant in a match with one or more other tournament participants. This can be done randomly using any number of suitable techniques known to those skilled in the art. Non-random techniques such as seeded pairings can also be used.

In a third step 106 the method involves broadcasting a display of each of the first round matches, each broadcasted display comprising a live stream of an in-game view for the one or more tournament participants in the match. The broadcast may simply involve showing the in-game views of the one or more participants together on a hosting webpage simultaneously.

In a fourth step 108 the method involves, for each first round match broadcast, detecting a visual trigger in the display indicating that the match has ended and thereby determining one or more winning tournament participants and one or more losing tournament participants. This step may be carried out by a smart machine-learning algorithm that has been trained using visual data for the game that is being played to detect the end of a game and the winners and losers of the game based on an in-game event or display.

For example, referring to FIG. 2, the algorithm may spectate the displayed match and detect that the text package 204 “#1 Victory Royale” has been displayed in association with a particular player or team, indicating that that team has come first in the game round. This is merely an illustrative example, and the algorithm may be trained on multiple different types of games using any number of suitable visual triggers.

Returning to FIG.1 , a fifth step 110 of the method involves generating a set of second round matches by pairing one or more winning tournament participants with one or more other winning participants. Thus, a winner such as the winner determined in FIG. 2 will be instantaneously paired with a winner of a different first round match in the same tournament.

Similarly, and optionally, losing participants or teams of participants may also be paired in lower/loser brackets using the same techniques.

Finally, in a sixth step 112 the method involves repeating steps 106-110 for each successive tournament round until one or more tournament winners are determined. The tournament is thus smoothly and automatically progressed as matches between opponents end and live streams of the entire tournament are easily accessible and organised for viewer convenience. An integrated e-sport experience is thus provided.

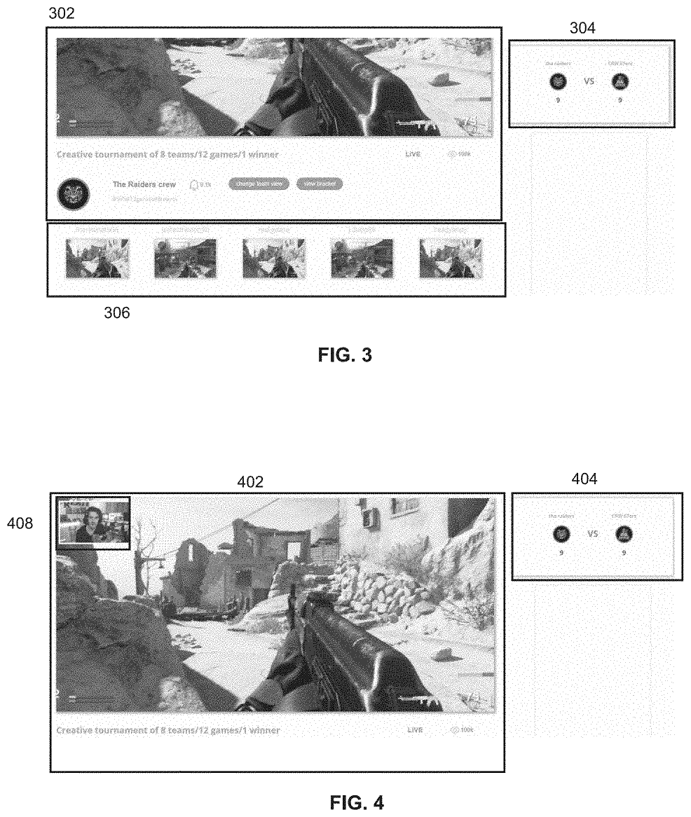

Referring to FIGS. 3 and 4, aspects of an example viewer hosting website interface are shown for two opposing teams competing in an online multiplayer game tournament that is being displayed according to the disclosed method.

The viewer interface may be configured such that a main enlarged display 302 shows the live stream of an in-game perspective of a first player on one of the teams with some text indicating data relating to the player such as the name of the team they are playing for and their username. To the right of the main display 302 is an information box indicating data relating to the ongoing match, i.e. the identity of the two teams participating in the match. Other data may be included. Beneath the main display is a row of thumbnails 306 representing each of the player's teammates, a viewer can switch the main display to view the in-game perspective of any one of the teammates by clicking on their respective thumbnail.

FIG. 4 shows a similar hosting webpage configuration to that of FIG. 3 with a main display 402 showing an in-game perspective of a player and an information box 404 on the competing teams. Also included in the top left corner of the main display 402 is a webcam box 408 displaying the facecam of the player whose in-game perspective is being shown.

It will be understood by the skilled person that the configurations of FIGS. 3 and 4 are purely illustrative of one example configuration that can be achieved using the disclosed method.

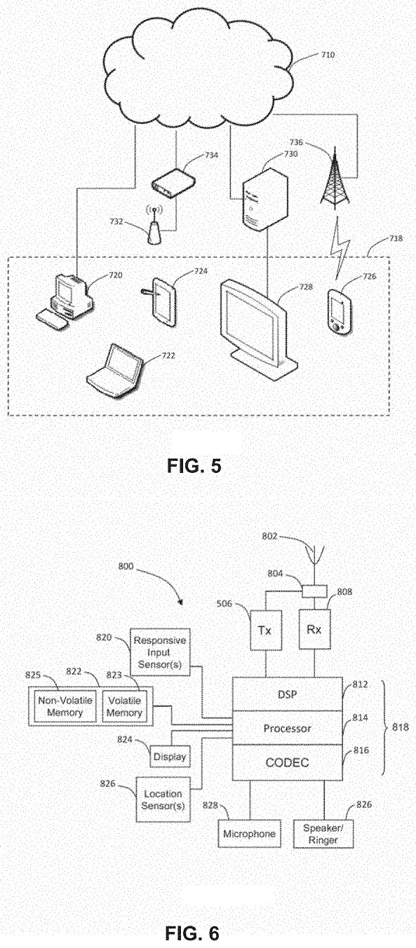

Referring to FIG. 5, an example system and network architecture through which the method of the present disclosure may be implemented is shown, wherein a server or cloud hosts and broadcasts the displayed game to multiple user devices via different communication methods.

The illustrative network 710 is configured to communicate with client devices 718. The illustrative client devices include a personal computer 720, a laptop 722, a tablet computer 724, a smartphone 726, and a display 728 that has a wired connection to a networked computer 730. The clients 718 may be operationally coupled to a wide area network (WAN) such as the Internet with a wireless connection. The wireless clients may be communicatively coupled to the WAN via a Wi-Fi (or Bluetooth) access point 732 that is communicatively coupled to an illustrative modem 734, which is communicatively coupled to the WAN. The wireless clients may also be communicatively coupled to the WAN using a proprietary carrier network that includes illustrative communication tower 736.

Referring to FIG. 6, an example configuration of a the electronic components of a user device capable of viewing a game tournament displayed according to the method of the present disclosure is shown.

For purposes of this patent, the illustrative wireless device 800 is a multimode wireless device that comprises a first antenna element 802 that is operatively coupled to a duplexer 804, which is operatively coupled to a multimode transmitter module 806, and a multimode receiver module 808.

An illustrative control module 818 comprises a digital signal processor (DSP) 812, a processor 814, and a CODEC 816 that are communicatively coupled to the transmitter 806 and receiver 808. It shall be appreciated by those of ordinary skill in the art that the transmitter module and receiver module are typically paired and may be embodied as a transceiver. The illustrative transmitter 806, receiver 808, or transceiver is communicatively coupled to antenna element 802.

The DSP 812 may be configured to perform a variety of operations such as controlling the antenna 802, the multimode transmitter module 806, and the multimode receiver module 808. The processor 814 is operatively coupled to a responsive input sensor 820 such as a keypad or a touch screen.

The processor 814 is also operatively coupled to a memory 822, a display 824, and a sensor 826. The sensor 826 may be used to determine an indoor and outside location for the illustrative wireless device.

Additionally, the processor 812 is also operatively coupled to the CODEC module 816 that performs the encoding and decoding operations and is communicatively coupled to a speaker 826, and a microphone 828. The CODEC module 816 is also communicatively coupled to the display 824 and provides the encoding and decoding operations for video.

The memory 822 includes two different types of memory, namely, volatile memory 823 and non-volatile memory 825. The volatile memory 823 is computer memory that requires power to maintain the stored information, such as random access memory (RAM). The non-volatile memory 825 can retain stored information even when the wireless communication device 800 is not powered up. Some illustrative examples of non-volatile memory 825 include flash memory, ROM memory, and hard drive memory.

Wireless device 800 may be a mobile handset, mobile phone, wireless phone, portable cell phone, cellular phone, portable phone, a personal digital assistant (PDA), a tablet, a portable media device, a wearable computer, or any type of mobile terminal which is regularly carried by an end user and has all the elements necessary for operation in a wireless communication system. The wireless communications include, by way of example and not of limitation, CDMA, WCDMA, GSM, UMTS, or any other wireless communication system such as wireless local area network (WLAN), Wi-Fi or WiMAX.

It should be understood that the operations described herein may be carried out by any processor comprising a distributed element. In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining”, “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the system for establishing trust between nodes in a network have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A computer-implemented method of displaying a multiplayer game in a tournament comprising one or more rounds, the method comprising:
a) receiving user data comprising a list of tournament participants;
b) generating a set of first round matches by pairing each tournament participant in a match with one or more other tournament participants;
c) broadcasting a display of each of the first round matches, each broadcasted display comprising a live stream of an in-game view for the one or more tournament participants in the match;
d) for each first round match broadcast, detecting a visual trigger in the display indicating that the match has ended and thereby determining one or more winning tournament participants and one or more losing tournament participants;
e) generating a set of second round matches by pairing one or more winning tournament participants with one or more other winning participants;
f) repeating steps (c)-(e) for each successive tournament round until one or more tournament winners are determined.

2. A computer-implemented method according to claim 1, wherein each match comprises opposing teams of first and second sets of tournament participants, and wherein step (c) comprises broadcasting a live stream for each participant of each team.

3. A computer-implemented method according to claim 1, wherein the method further comprises pairing losing participants for each round subsequent to the first round and broadcasting the live streams of the losing participants.

4. A computer-implemented method according to claim 1, wherein step (d) is carried out by a machine learning algorithm that has been trained to detect visual triggers and determine winning participants based on the in-game display of a particular game that is being played.

5. A computer-implemented method according to claim 5, wherein the visual trigger is an in-game event which is automatically generated once a game has ended.

6. A computer-implemented method according to claim 1, wherein the live streams of the in-game displays are broadcast on a streaming website.

7. A computer-implemented method according to claim 6, wherein for team games the streaming website displays two team names indicating the teams that are playing.

8. A computer-implemented method according to claim 6, wherein for team games the streaming website displays an enlarged in-game view for a particular tournament participant on each team.

9. A computer-implemented method according to claim 8, wherein the display further comprises a set of thumbnails representing one or more tournament participants on the same team as the displayed tournament participant, and the streams of the one or more team members can be accessed via the respective thumbnails.
